(19) United States
(12) Patent Application Publication
(10) Pub. No.: US 2012/0278201 A1
(43) Pub. Date: Nov. 1, 2012

(54) Location transaction processing system

(75) Inventor: Benjamin P. Milne, Newton, IA (US)

(73) Assignee: Dwolla Corp.

(21) Appl. No.: 13/066,812

(22) Filed: Apr. 26, 2011

(51) Int. Cl. G06Q 30/00; G06Q 40/00

(52) U.S. Cl. 705/26.41; 705/44; 705/39

(57) ABSTRACT

A system for identifying the location of a user and presenting the user with the location of nearby merchants that accept payment from a payment system associated with the user's mobile communication device. Upon opening an application associated with the system within the mobile communication device, the user is presented with a map of the user's location, including tags of nearby merchants that accept the payment system. The user may choose a particular merchant by selecting the tag on the map associated with that merchant. The user may input a personal identification number and a payment amount, which authorizes the transfer of funds from a user account to the merchant account via the mobile communication device.

### TECHNICAL FIELD

The disclosed embodiments relate generally to financial transactions, and, in particular, to using location information associated with a mobile communication device to locate and transfer funds to a nearby recipient.

### BACKGROUND

Novel payment systems utilizing mobile communication devices are known in the art. Such devices allow a user to transmit funds to a recipient via the user's authorization of the transfer using the mobile communication device. Such transactions may be authorized by swiping a credit card, charge card or debit card across the mobile communication device or accessing a payment system via the mobile communication device to authorize the transfer of funds.

One drawback associated with prior art systems is that it is difficult to determine which retailers or other recipients agree to accept funds via the particular payment system. If the ratio of retailers to accept the payment system is very low in relationship to the retailers who do not accept the payment system, it is unlikely a user will query each retailer to determine if the payment system is acceptable. If users to not query if the payment system is acceptable, retailers have little incentive to accept the novel payment system and a critical mass of users and retailers is often not obtained. It would be desirable to provide a fund transfer system using a mobile communication device that indicated which retailers or recipient accepted the payment system.

Another drawback associated with prior art systems is that even if a user is aware that a particular retailer or recipient accepts the desired payment system, the user is often required to input information identifying the retailer into the mobile communication device before the payment can be made. Depending on the particular transaction system, imputing the information relating to the particular retailer may take the majority of time associated with the transaction. If conducting the transaction via the mobile communication device is overly burdensome or lengthy, users are dissuaded from using the system and it is difficult to obtain a critical mass of users and retailers. It would, therefore, be desirable to provide a system which facilitated the entry of information identifying the retailer.

One drawback associated with prior art systems is the requirement that both the user and recipient be available to authorize the transaction. In some situations, such as a non-profit donation site, it would be desirable to allow a user to make a payment to a non-profit entity without the requirement that the non-profit entity be available to authorize the transaction.

Another drawback associated with prior art devices is the requirement that the user present a card or some other item within a close proximity to a recipient reading device such as a card swipe or proximity detector. It would be desirable to allow the payment of funds from a user to a recipient without the need of a specific requirement that the user come within a specific proximity to a recipient device. It would also be desirable to allow a user to transfer funds to a recipient without the requirement that the recipient have a particular specialized hardware.

Another drawback associated with the prior art is the requirement that a user provide a recipient of a payment with specific financial information, such as the user's name and address, and information such as that contained on a check or credit card. It would be desirable to allow the user to make a payment to the recipient without the need to provide any particular financial information associated with the user.

Still another drawback of the prior art is the storage of user financial information by the recipient. In prior art systems, a when a user makes a purchase from a recipient using something other than cash, the recipient typically stores information associated with the user, such as credit card information or information contained on the user's check or debit card.

The difficulties encountered in the prior art described hereinabove are substantially eliminated by the present invention.

### SUMMARY OF THE DISCLOSED SUBJECT MATTER

The deficiencies described above are overcome by the disclosed implementation of a location based fund transfer. A user with a mobile communication device queries the system for information related to nearby recipients that accept the payment system. The system uses location information provided by the mobile communication device to query a database of recipients that accept the payment system and are located within a predetermined distance from the mobile communication device. The system provides the mobile communication device with a map tagged with the locations of nearby recipients accepting the payment system. The user selects the desired recipient from the tagged map and the system provides the mobile communication device with a fund transfer interface. The user enters the desired amount of the transaction into the interface and authorizes the transaction. The system receives the authorization and transfer the funds to the desired recipient. The system sends a confirmation to a communication device associated with the recipient.

Other implementations of location based fund transfer are disclosed, including implementations directed to systems, methods, apparatuses, computer-readable mediums and user interfaces.

### BRIEF DESCRIPTION OF THE DRAWINGS

The present invention will now be described, by way of example, with reference to the accompanying drawings in which:

FIG. 1 illustrates a block diagram of the system architecture in accordance with one embodiment;

FIG. 2 illustrates a flow diagram of an exemplary location fund transfer process;

FIG. 3 illustrates an example display from an application running on a mobile communication device, the display showing the log-in page for the application;

FIG. 4 illustrates an example display from an application running on a mobile communication device, the display showing a map of the user's location, tagged with recipients that accept the location based fund transfer system;

FIG. 5 illustrates an example display from an application running on a mobile communication device, the display showing information related to the selected recipient;

FIG. 6 illustrates an example display from an application running on a mobile communication device, the display showing the transaction amount screen;

FIG. 7 illustrates an example display from an application running on a mobile communication device, the display showing the fund transfer authorization screen;

FIG. 8 illustrates an example display from an application running on the recipient's communication device, the display showing the confirmation screen identifying the amount of the fund transfer from the user.

### DETAILED DESCRIPTION OF THE DRAWINGS

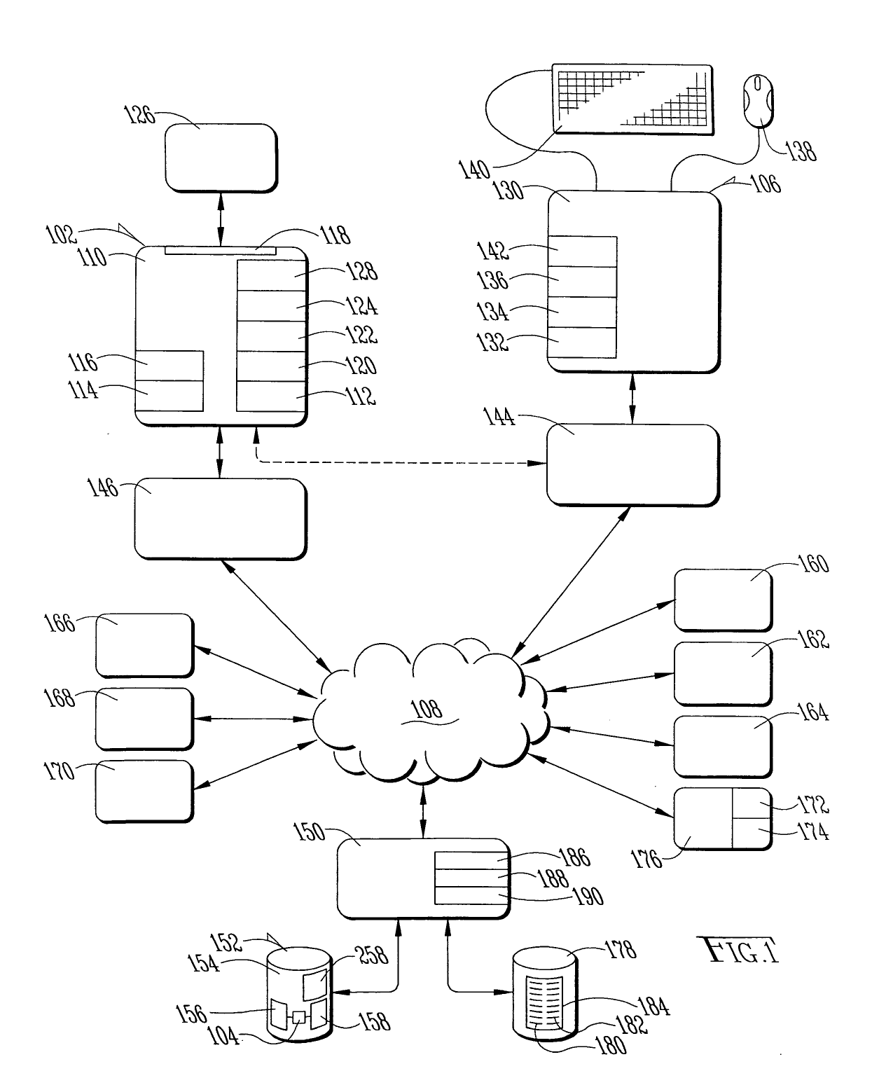

As shown in FIG. 1, a transaction processing system (100) is provided to allow a user (102) to transfer funds (104) to a recipient (106) across a network (108). As shown in FIG. 1, the user (102) may use a mobile communication device (110) to transfer the funds (104). The mobile communication device (110) may be of any type known in the art, including, but not limited to, a notebook, netbook, net tablet, smartphone or any device having the capability of communicating over a network (108). In an embodiment, the mobile communication device (110) is provided with network access applications known in the art, such as a browser (112) to facilitate communication over the network (108). The mobile communication device (110) is also preferably provided with a central processing unit (114), a battery (116), an antenna (118) and a location based funds transfer system application (120). The application (120) may be any type of computer program incorporating the functionality described below. The mobile communication device (110) is provided with display (120) and a keyboard (122) or other known data input devices. The keyboard (122) may be a physical keyboard or a virtual keyboard, which is touch sensitive and appears on the display (120) when needed.

The network (108) may be of any type known in the art, including, but not limited to, the Internet, a local area network (ALN), a wide-area network (WAN), telephony or any combination thereof. The mobile communication device (110) is provided and configured to execute computer executable instructions that cause the application (124) and browser (112) to perform the method detailed more fully below.

The antenna (118) is preferably capable of receiving signals from a location signal generator (126). The location signal generator (126) may be of any type known in the art, including, but not limited to, a global positioning system of satellites, a telephony tower, Wi-Fi router, or any device known in the art. Preferably, the location signal generator (122) includes a plurality of signal generators to allow a location application (124) of the mobile communication device (110) to triangulate the location of the mobile communication device (110) to determine a more precise latitude and longitude of the mobile communication device (110). Alternatively, the location signal generator (126) may be a single cellular telephone tower or Wi-Fi router that allows the mobile communication device (110) to determine its location within a general area.

Also shown in FIG. 1 is a communication device (130) associated with the recipient (106). The communication device (130) may be of any type known in the art, including, but not limited to a desktop, workstation, notebook, netbook, net tablet, mainframe, terminal, smartphone or any device having the capability of communicating over a network (108). The communication device (130) is provided with a browser (132) such as that described above, central processing unit (134), a display (136) and input device, such as a mouse (138) and keyboard (140), or any other input device such as those known in the art.

As noted above, the keyboard (140) may be physical or may be a virtual keyboard which appears on the display (136) as needed. The communication device (130) is also provided with a location based funds transfer system application (142). If desired, the communication device (130) may be provided with a battery and antenna (not shown) if it is desired to make a communication device more portable or if it is desired to communicate information wirelessly. The communication device (130) is provided with a location based funds transfer system application (142). The application (142) may be similar to the application (124) described above or may be customized to the recipient to perform the method detailed more fully below.

As shown in FIG. 1, the communication device (130) is coupled to a router (144) which may be of any type known in the art. The router (144) may be hardwired to the communication device (130) or may be coupled to the communication device (130) via a wireless connection. If desired, the router (144) may be provided with a public access option, allowing the mobile communication device (110) to connect wirelessly to the router (144). Alternatively, the mobile communication device (110) may connect to the network (108) via a connection point which may be a router coupled via a hardwire or wirelessly to the mobile communication device (110), a telephony tower such as that known in the art, or any known system for coupling a mobile communication device (110) to a network (108).

As shown in FIG. 1, an external financial system (148) is shown coupled to the network (108). While the external financial system (148) may be of any type known in the art, an embodiment of an external financial system (148) that may be adapted to the present system (100) is described in U.S. patent application Ser. No. 12/658,278, which is incorporated herein by reference. The external financial system (148) is provided with a server (150). The server (150) may be of any suitable type known in the art.

The server (150) is coupled to an account database (152) which may, if desired, be incorporated into the server (150). The account database (152) contains a plurality of financial accounts (154), including a user account (156) associated with the user (102) and a recipient account (158) associated with the recipient (106). The account database (152) also includes additional financial accounts (154) associated with other users (160), (162) and (164) and other recipients (166), (168) and (170). The financial accounts (154) are preferably set up prior to conducting a transaction. The user (102) and recipient (106) may access the external financial system (148) via the network (108) to create a financial account (154) in a manner such as that known in the art. If desired, the user (102) and recipient (106) may transfer the funds (172) from an account (174) in a financial institution (176) previously funded by the user (102) or recipient (106). Alternatively, the user (102) and recipient (106) may fund the user account (156) and recipient account (158) directly via cash or any other type of transaction known in the art.

Also coupled to the server (150) is a location database (178) which may, if desired, be incorporated into the server (150). The location database (178) includes an index (180) of recipients (182) associated with respected locations (184). Preferably, the location database (178) is propagated by the recipients (106), (166), (168) and (170) when they initially set up an account with the external financial system (148). Alternatively, the location database (178) may obtain the locations (184) via a third party resource, such as records of incorporation or information obtained from the local tax assessment authority.

The server (150) is also preferably provided with a network communication application, such as a browser (186), a central processing unit (188) and internal systems (190) configured to execute computer instructions to cause the server (150) to perform the method detailed more fully below.

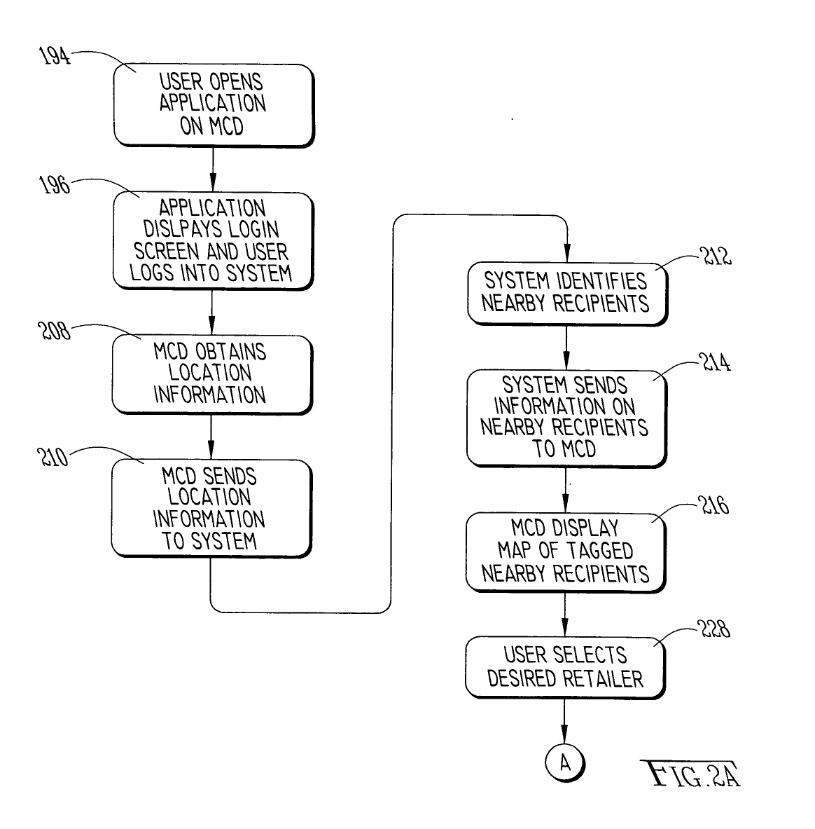

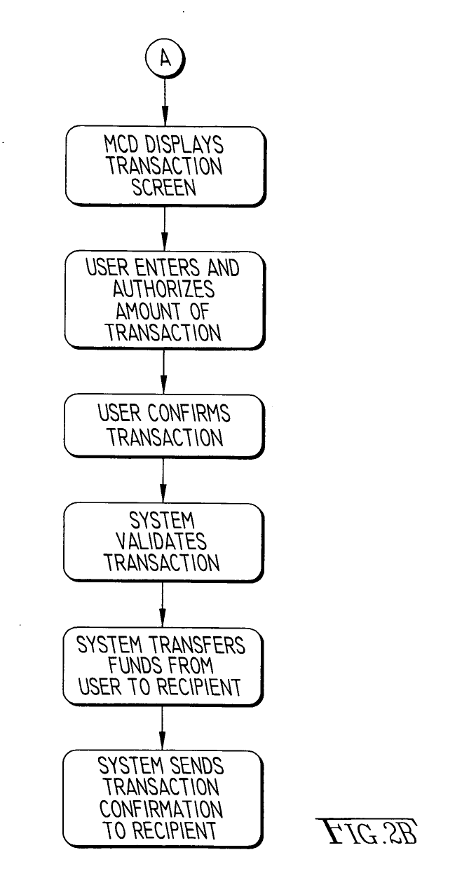

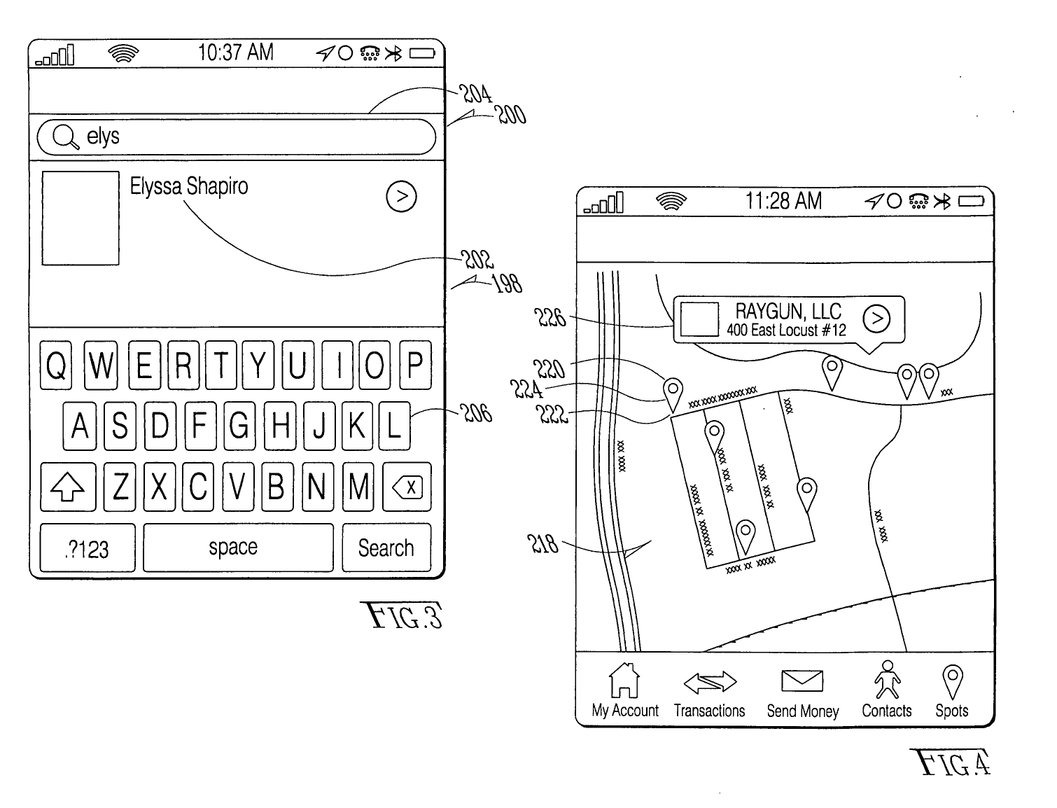

FIG. 2 is a flow diagram of an exemplary location based funds transfer process (192). The steps of the process (192) do not have to occur in a specific order and may occur in parallel. The funds transfer process (192) begins when a user (102) opens (194) the application (124) associated with the transaction processing system (100). In response, the application (124) displays (196) on the display (120) of the mobile communication device (110) a log-in page (198) associated with the transaction processing system (100). The log-in page (198) may request a user name and password in a manner such as that known in the art or, as shown in FIG. 3, may display a list of accounts (200) allowing the user (102) to select the desired account (202) from the list.

As shown in FIG. 3, the log-in page (198) may be provided with a search term field (204) and keyboard (206) to allow a user (102) to search for a specific desired account (202). Once the user (102) logs into the system (100), the mobile computing device (110) obtains (208) location information associated with the mobile communication device (110). The mobile communication device (110) obtains this information from the location signal generator (126). Alternatively, the mobile communication device (110) may obtain this information from an alternate source, such as a router (144) associated with the recipient (106), or a connection point (146) coupling the mobile communication device (110) to the network (108). Once the mobile communication device (110) obtains (208) the location information, the mobile communication device (110) sends the location information to the external financial system (148).

Upon receipt of the location information, the server (150) associated with the external financial system (148) uses the internal systems (190) to search the location database (178) for a list of recipients (182) associated with locations (184), nearby the location provided by the mobile communication device (110).

Once the external financial system (148) has identified (212) recipients (182) with locations (184) nearby to the mobile communication device (110), the server (150) sends (214) the information related to the recipients (182) and locations (184) via the network (108) to the mobile communication device (110). Upon receipt of the information relating to recipients (182) and locations (184), the mobile communication device (110) displays (216) a map (218) with tags (220) associated with locations of the recipients (224). As shown in FIG. 4, the user (102) may select a tag (220) to open a pop-up window (226) with additional information associated with the recipient (224). Alternatively, the mobile communication device (110) may simply provide a list of nearby recipients (224) and locations (222) from which the user (102) may select.

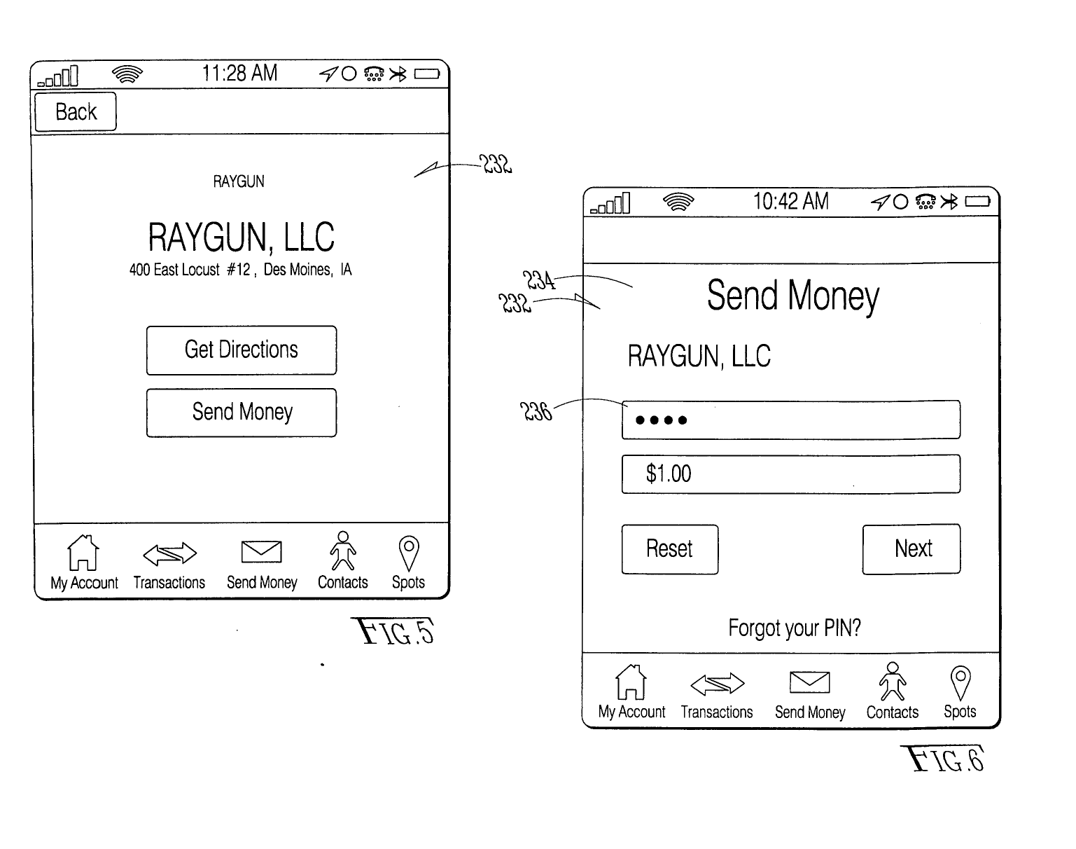

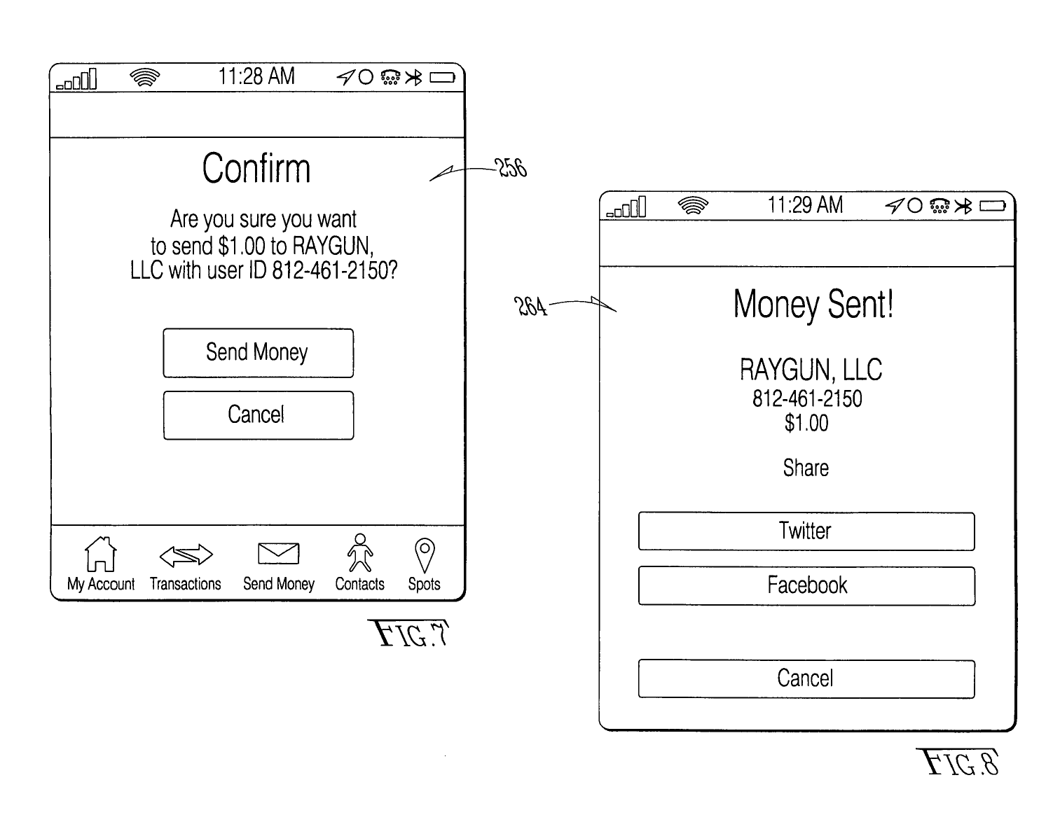

From the tags (220) on the map (218), the user (102) selects (228) the recipient (106) desired by the user (102). Once the user (102) selects (228) the desired recipient (106), the mobile communication device (110) displays (230) a transaction screen (232) such as that shown in FIG. 6. The transaction screen (232) provides the name (234) of the recipient (106), a code field (236) and a payment field (238). The user (102) enters a personal identification number (PIN) (242) in the code field (236) and enters (244) the transaction amounts (246) in the payment field (238). If the PIN (242) or transaction amount (246) are incorrect, the user (102) will press the reset button (248) to clear the code field (236) and payment field (238). If the PIN (242) and transaction amount (246) are correct, the user (102) confirms (250) the transaction by selecting the “next” button (252) on the transaction screen (232), which sends the PIN (242), the transaction amount (246) and the authorization (250) to the external financial system (148) via the network (108).

Upon receipt of the PIN (242) and transaction amount (246), the server (150) checks the PIN (242) and transaction amount (246) against the user account (156) in the account database (152) and confirms (254) the transaction by confirming the PIN (242) is valid and the transaction amount (246) is less than or equal to the amount of funds (104) in the user account (156). If the PIN (242) is incorrect, or the transaction amount (246) is greater than the amount of funds (104) in the user account (156), the system returns an error message to the mobile communication device (110), which presents the error message on the display (120) for the user (102). If the PIN (242) and transaction amount (246) are correct, the system transfers the funds (104) in the transaction amount (246) from the user account (156) to the recipient account (158). If desired, additional amounts may be transferred from the user account (156) to a system account (258) as a fee for the transaction. While the user account (156) and recipient account (158) are shown in FIG. 1 as being provided in the same database, if desired the user account (156) and recipient account (158) may be in separate databases, separate servers, or may even be affiliated with separate institutions having a system agreement in place sufficient to allow the foregoing transaction.

Once the transfer of funds (104) from the user account (156) to the recipient account (158) has been completed, the external financial system (148) sends (260) a transaction confirmation from the server (150) across the network (108) and router (144) to the communication device (130) associated with the recipient (106). The communication device (130) displays the confirmation on the display (136). Once the recipient (106) has received the confirmation, the recipient (106) may provide the user with a good or a service.

In the preferred embodiment, the recipient (106) is a static entity such as a retail store. The system (100) may be used in association with any desired type of recipient (106). The recipient (106) may be an individual with a communication device (130) which is also a mobile communication device (110), thereby allowing the external financial system (148) to locate a recipient (106) using a location application associated with a recipient's communication device (130). The recipient (106) may be other types of mobile recipients, such as a taxi or bus. The recipient (106) may be a location, such as a monument where donations may be made, or may be a transient entity, such as a farmers market.

While the location information associated with the recipient (106) is preferably provided by the recipient (106), the location information may be provided by a third party provider, such as a third party address index or telephone number listing service.

Additionally, while in the preferred embodiment the system (100) provides a map indicating both the location of the user (102) and the recipient (106), if desired the system may be designed to allow the user (102) to input a specific geographic location, such as a zip code, area code, point of interest or longitude and latitude to find recipient (106) in a location other than the specific location of the user (102). Also, while in the preferred embodiment the system (100) immediately confirms to the recipient (106) that the payment has been made from the user (102), the system may allow the user to delay the confirmation or to place the payment into escrow and to confirm to the recipient that the payment has been placed into escrow until some additional criteria have been met regarding the payment.

The system (100) may allow the user (102) to filter recipients by various criteria, such as restaurants, static locations, or entities offering a special offer or discount. Recipients (106) may also be allowed to pay additional monies into the system (100) or offer particular discounts to appear on the system (100), or to be more prominently featured within the system.

In an alternative embodiment of the present invention, the recipient may provide the system (100) with additional information, such as a restaurant menu or a user database, allowing the system (100) to specifically facilitate the provision of goods or services to a user (102). If the recipient (106) is a restaurant, and the user walks into the restaurant and opens the application, the system (100) may display on the user's mobile communication device (110), a menu associated with the recipient restaurant, allowing the user to purchase products from the menu by selecting a tag associated with the menu items. A recipient (106) or a wait staff person associated with the recipient (106) may also add a mobile communication device (110) to which the system (100) confirms the selection of the menu items along with the confirmation of payment. The system (100) may simultaneously confirm the order to the kitchen staff to expedite the provision of the menu items to the user (102). The recipient (106) may also provide purchase data associated with the user (102) so that when the user (102) enters a recipient's establishment, and launches the application associated with the system (100), the system (100) displays items which the user (102) has purchased in the past or, based upon prior purchases, may be more likely to purchase in the future. The user (102) may then select and purchase such items by selecting a tag on the display associated with the items.

Although the invention has been described with respect to a preferred embodiment thereof, it is to be understood that it is not to be so limited since changes and modifications can be made therein which are within the full, intended scope of this invention as defined by the appended claims.

What is claimed is:

1. A method for paying a transaction comprising:
(a) providing a mobile communication device associated with a user;
(b) providing a communication device associated with a recipient;
(c) providing an external financial database;
(d) creating a user account;
(e) associating the user account with the external financial system;
(f) creating a recipient account;
(g) associating the recipient account with the external financial system;
(h) determining a first geographic location associated with the mobile communication device;
(i) displaying information associated with the recipient on the mobile communication device;
(j) authorizing a transaction between the user and the recipient;
(k) displaying a transaction interface on the mobile communication device;
(l) authorizing the transfer of a predetermined amount of funds from the user account to the recipient account;
(m) transferring the predetermined amount of funds for the user account to the recipient account; and
(n) displaying a fund transfer confirmation on the communication device associated with the recipient.

2. The method for paying for a transaction of claim 1, wherein the recipient is a retailer.

3. The method for paying for a transaction of claim 1, wherein displaying information associated with the retailer comprises:
(a) generating a map which includes the second geographic location associated with the recipient on the mobile communication device;
(b) displaying the map on the mobile communication device; and
(c) displaying a tag on the map associated with the second geographic location associated with the recipient on the mobile communication device.

4. The method for paying for a transaction of claim 3, wherein determining a second geographic location associated with the recipient comprises:
(a) associating a recipient database with the external financial database;
(b) storing information on the recipient database;
(c) wherein the information comprises an index of potential recipients and geographic locations associated with the potential recipients; and
(d) selecting the recipient from the recipient database based upon the recipient's proximity to the first geographic location.

5. The method for paying for a transaction of claim 4, wherein determining a first geographic location associated with the mobile communication device comprises determining a first geographic location associated with the mobile communication device using a global positioning system.

6. The method for paying for a transaction of claim 4, wherein determining a first geographic location associated with the mobile communication device comprises determining a first geographic location associated with the mobile communication device using signal triangulation.

7. The method for paying for a transaction of claim 3, wherein determining a first geographic location associated with the mobile communication device comprises determining a first geographic location associated with the mobile communication device using a global positioning system.

8. The method for paying for a transaction of claim 1, wherein determining a first geographic location associated with the mobile communication device comprises determining a first geographic location associated with the mobile communication device using a global positioning system.

9. The method for paying for a transaction of claim 1, wherein the communication device associated with the recipient comprises a mobile communication device.

10. The method for paying for a transaction of claim 9, wherein determining a second geographic location associated with the recipient comprises determining a second geographic location associated with the recipient using a global positioning system.

11. The method for paying for a transaction of claim 1, wherein determining a second geographic location associated with the recipient comprises determining a second geographic location associated with the recipient using a global positioning system.

12. The method for paying for a transaction of claim 1, wherein the external system is associated with a financial system.

13. A method for paying for a transaction comprising:
(a) providing a mobile communication device associated with a user;
(b) providing a communication device associated with a recipient;
(c) providing an external financial database;
(d) creating a user account;
(e) associating the user account with the external financial system;
(f) creating a recipient account;
(g) associating the recipient account with the external financial system;
(h) associating a recipient database with the external financial database;
(i) storing information on the recipient database, wherein the information comprises:
(i) a plurality of potential recipients;
(ii) a plurality of geographic locations associated with the potential recipients;
(j) using the mobile communication device to determine a geographic location associated with the mobile communication device; and
(k) selecting the recipient from the recipient database based upon the distance of the recipient from the geographic location.

14. The method for paying for a transaction of claim 13, wherein the recipient is a retailer.

15. The method for paying for a transaction of claim 13, further comprising tagging the map with a plurality of potential recipients having geographic locations located on the map.

16. The method for paying for a transaction of claim 13, wherein using the mobile communication device to determine a geographic location associated with the mobile communication device comprises using a global positioning system to determine the geographic location.

17. The method for paying for a transaction of claim 13, wherein using the mobile communication device to determine a geographic location associated with the mobile communication device comprises using signal triangulation to determine the geographic location.

18. A financial transaction system comprising:
(a) a mobile communication device;
(b) a communication device;
(c) a server comprising:
(i) a processor;
(ii) memory that stores instructions for causing the processor to perform the following operations:
(1) maintaining data indicating a user account;
(2) maintaining data indicating a recipient account;
(3) determining a first geographic location associated with a user; and
(4) determining a second geographic location associated with a recipient;
(5) sending information to the mobile communication device;
(6) receiving a fund transfer authorization from the mobile communication device;
(7) transferring a predetermined amount of funds associated with the authorization from the user account to the recipient account; and
(8) sending a fund transfer confirmation to the communication device.

19. The financial transaction system of claim 18, wherein using the mobile communication device to determine a geographic location associated with the mobile communication device comprises using a global positioning system to determine the geographic location.

20. The financial transaction system of claim 18, wherein using the mobile communication device to determine a geographic location associated with the mobile communication device comprises using signal triangulation to determine the geographic location.
